(19) United States
(12) Patent Application Publication
(10) Pub. No.: US 2013/0155483 A1
(43) Pub. Date: Jun. 20, 2013

(54) Optical Fiber Free Space Isolator and Method of Forming the Same

(71) Applicants: Near MARGALIT, Westlake Village, CA (US); Leo Ye, Alameda, CA (US)

(72) Inventors: Near MARGALIT, Westlake Village, CA (US); Leo Ye, Alameda, CA (US)

(21) Appl. No.: 13/342,668

(22) Filed: Jan. 3, 2012

(30) Foreign Application Priority Data
Dec. 14, 2011 (CN) 201110416759.4

(51) Int. Cl. G02F 1/09; B32B 37/14; B32B 37/12

(52) U.S. Cl. 359/280; 156/293

(57) ABSTRACT

The present disclosure provides an optical fiber free space isolator. The optical fiber free space isolator can be used with various laser devices, and includes a magnetic support and an optical subassembly. The magnetic support is mounted at the output port of a laser device, and the optical subassembly is fixed to the magnetic support. The optical subassembly may be housed in a U-shaped slot formed in the magnetic support. The present invention further includes an assembly method for the optical fiber free space isolator.

### CROSS REFERENCE TO RELATED APPLICATION(S)

This application claims the benefit of Chinese Patent Application No. 201110416759.4, filed on Dec. 14, 2011, which is hereby incorporated by reference as if fully set forth herein.

### BACKGROUND OF THE DISCLOSURE

1. Field of the Disclosure

The present invention provides an optical fiber free space isolator. The optical fiber free space isolator of the present invention pertains to various laser devices, and includes a magnetic support and an optical subassembly. The magnetic support is mounted at an output port of the laser device, and the optical subassembly is fixed to the magnetic support. The magnetic support has a U-shaped slot in which the optical subassembly is mounted. An optical fiber free space isolator in accordance with the present invention has benefits over conventional optical isolators, including quick assembly, which allows for more efficient and/or automated mass production. The improved manufacturing efficiency of the presently disclosed optical fiber free space isolators facilitates long-term development of cost-effective manufacturing and assembly enterprises. The present invention further provides a method for assembling the optical fiber free space isolator.

2. Discussion of the Related Art

An optical isolator is a passive optical device that allows only unidirectional light to pass. An isolator will allow light to be transmitted in a certain direction, while blocking light in the opposite direction (e.g., light reflected by an optical fiber back toward the origin of the light). Based on the directionality of Faraday rotation, back-reflection of light (signal reflection toward the light's origin) that occurs in optical fibers can be strictly isolated by the optical isolator. Thus, an optical isolator can also be called an optical fiber free space isolator. An optical isolator is ideally characterized by low insertion loss, a high degree of isolation, and a high attenuation of return loss (i.e., an optical isolator is a passive optical device that enables light to pass through in a single direction but not in the opposite direction). An optical isolator is used to restrict the direction of light to one-way transmission. Furthermore, because an optical isolator strictly isolates light back-reflected by an optical fiber, optical transmission efficiency and the service life of an optical source (e.g., a laser) can be increased, and undesirable impacts due to reflected light can be prevented.

Conventional optical fiber space isolators can be mounted on the front of a laser to ensure the transmission efficiency of the laser and maximize the service life of the laser. Generally, an optical fiber space isolator comprises a magnetic support and an optical subassembly. The magnetic support can be fixed to the laser device in order to support the isolator and provide the optical subassembly with an essential magnetic field. The optical subassembly can be fixed to the magnetic support, providing an optical isolator for the laser that isolates any light reflected back toward the laser. However, the assembly of such an optical fiber free space isolator is complicated and time-consuming. In the assembly process, each side of the optical subassembly has one swing link that must be manually added using a pair of relatively fine, sharp tweezers or forceps (the swing link is used for auxiliary placement so that the optical subassembly can be placed at the center of a circular magnet ring), and then the optical subassembly is placed in the through hole of the circular magnet ring, and subsequently the gap between the through hole and the optical subassembly is filled with a defined amount of adhesive dispensed by a fine needle (e.g., having a diameter about 0.06 mm) so that the optical subassembly can be fastened to the circular magnet ring. In order to ensure the whole mounting process proceeds accurately, it must be conducted by skilled operators using precision tools, such as microscopes and electronics forceps, which results in relatively low assembly efficiency, disadvantages for mass production, and limitations on enterprise development.

### SUMMARY OF THE INVENTION

The present invention is directed to an optical fiber free space isolator and a method for assembling the same. In the assembly method of the present invention, the optical fiber free space isolator can be assembled more efficiently in substantially reduced time, which is beneficial to automated mass production and the long-term development of cost-effective manufacturing enterprises that make such devices.

The present invention provides an optical fiber free space isolator suitable for being mounted on various lasers and/or laser sources, comprising a magnetic support fixed to an output port of the laser, and an optical subassembly fixed to the magnetic support, where the magnetic support has a U-shaped slot and the optical subassembly is mounted inside the U-shaped slot.

Preferably, the width of the U-shaped slot corresponds to the width of the optical subassembly (e.g., the width of the U-shaped slot is equal to or slightly larger than the optical subassembly). Also, the length of the U-shaped slot is preferably greater than the length of the optical subassembly. Preferably, the center line of the magnetic support aligns with the center line of the laser beam emitted from the laser. Also, the center line of the optical subassembly preferably aligns with the center line of the magnetic support. Preferably, a bottom surface of the U-shaped slot has a layer of adhesive to adhere the optical subassembly to the U-shaped slot. Preferably, the optical subassembly includes one or more polarizers and an optical rotator.

The present invention further provides an assembling method for an optical fiber free space isolator, comprising: a) forming a U-shaped slot in a magnetic support; b) applying a layer of adhesive to a bottom surface of the U-shaped slot; c) inserting an optical assembly into the U-shaped slot and adhering the optical subassembly to the adhesive layer; and d) mounting the magnetic support on a laser-emitting device.

Relative to existing optical isolator technologies, the present invention has several advantages. For example, the magnetic support has a U-shaped slot with an adhesive layer therein, and the optical subassembly is mounted in the U-shaped slot and bonded to the adhesive layer, without the need for highly skilled workers or precision manufacturing techniques. As a result, the optical subassembly can be placed in the magnetic support directly, quickly, and efficiently via the U-shaped slot, which speeds up the process of manufacturing and/or assembling the optical fiber free space isolator and increases assembly efficiency. Additionally, adhesive can be accurately and evenly applied to the bottom end face of the U-shaped slot via a dispenser, which can further enhance the quality and efficiency of the assembly method, improving the automated mass production of the optical fiber free space isolator.

Additional advantages, objects, and features of the disclosure will be set forth in part in the description which follows and in part will become apparent to those skilled in the art upon examination of the following or may be learned from practice of the invention. The objectives and other advantages of the invention may be realized and attained by the structure(s) and method(s) particularly pointed out in the written description and claims hereof, as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings have been included herein inn order to aid in the description of the embodiments of the present invention and the technical aspects thereof, and constitute a part of this application. The drawings present example illustrations and/or example embodiments of the present invention, and do not limit the present invention in any way. Without creative contribution, one skilled in the art also can utilize these drawings to obtain other embodiments.

FIG. 1 is a diagram showing the three-dimensional structure of an exemplary optical fiber free space isolator in accordance with the present invention.

FIG. 2 is a cutaway view showing the optical fiber free space isolator of FIG. 1 mounted on a laser.

FIG. 3 is a front view showing the optical fiber free space isolator of FIG. 1.

FIG. 4 is a process flow diagram showing the assembly process of an optical fiber free space isolator in accordance with the present invention.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts. It will be understood that the descriptions are not intended to limit the invention to these embodiments.

Referring to FIGS. 1-3, an optical fiber free space isolator 100 may be mounted on the front of a laser device 200. After passing through optical fiber free space isolator 100, a laser beam emitted from laser device 200 is transmitted through the optical fiber free space isolator 100. The isolator attenuates back-reflected light and prevents it from reaching and damaging the laser device 200. As shown in FIG. 1, optical fiber free space isolator 100 comprises magnetic support 110 and optical subassembly 120. Magnetic support 110 is fixed to an output port in the front of laser device 200. To facilitate proper operation of the laser device 200, the center line of the laser aligns with the center line of magnetic support 110. Thus, the laser beam can be emitted from the center of magnetic support 110. Also, magnetic support 110 houses an optical subassembly 120 and provides an essential magnetic field for creating Faraday rotation in the optical rotator 122 of the optical subassembly 120.

Optical subassembly 120 may include one or more polarizers and an optical rotator for producing a Faraday rotation in the laser beam emitted from the laser device 200. The polarizers may comprise a birefringent material, such as calcite, silicon dioxide, silicon carbide, titanium oxide, aluminum oxide, and other known birefringent materials. The polarizers may also comprise a polarizing beam splitter (PBS) cube or dichroic glass. The polarizers may further comprise an anti-reflective coating layer. The optical rotator may include one or more materials having a high Verdet constant, a low absorption coefficient, and a low non-linear refractive index, such as terbium-doped borosilicate glass, terbium gallium garnet crystal (TGG), and rare-earth iron garnets (e.g., yttrium-iron garnet [YIG]).

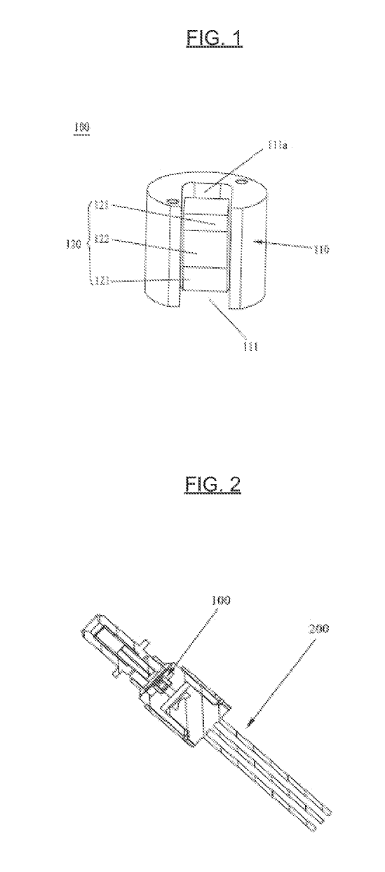

In one embodiment, the optical subassembly includes two polarizers 121 and an optical rotator 122, which are fixed to magnetic support 110 so that they are also secured to laser device 200, as shown in FIGS. 1-2. Polarizers 121 work in cooperation with optical rotator 122 to propagate the laser light away from the laser device 200 with low insertion loss and prevent back-reflection of the laser light toward the laser device 200, thereby preventing damage to the laser device 200. The center lines of polarizers 121 and optical rotator 122 align with the center line of the magnetic support 110, and thus the center lines of the laser, the magnetic support 110, the polarizers 121, and the optical rotator 122 are aligned with one another. For example, the output port of laser device 200, the magnetic support 110, and the optical subassembly 120 are aligned so that the optical subassembly 120 is concentric with the output port of the laser device 200. Due to the described alignment, the laser beam emitted from the laser device 200 and centered with polarizers 121 and optical rotator 122 can be more effectively optically adjusted via polarizers 121 and optical rotator 122. The operating principles of polarizers 121 and optical rotator 122 are generally known in the art, and thus a detailed description of the functions of polarizers 121 and optical rotator 122 is not provided.

The magnetic support 110 has a U-shaped slot 111 that goes through magnetic support 110 (as shown in FIG. 1), and optical subassembly 120 is mounted in the U-shaped slot 111. The bottom surface 111a of U-shaped slot 111 has a layer of adhesive (not shown) thereon. During assembly, the optical subassembly 120 is inserted in the U-shaped slot 111 and adhered to the adhesive layer, fixing optical subassembly 120 in U-shaped slot 111 and completing the assembly of optical fiber free space isolator 100. The process of adhering the optical subassembly to the adhesive layer can be automated, making the assembly of the optical fiber free space isolator 100 faster, more efficient, and more cost-effective.

In order to prevent the adhesive layer from interfering with the normal operation of a laser device (e.g., blocking or diffracting the laser, etc.), the adhesive layer may be applied to the bottom surface 111a in a predetermined pattern. For instance, the adhesive layer may be a line of adhesive that runs down the length of the bottom surface 111a of the U-shaped slot 111 and is aligned with the center of the magnetic support 110. The adhesive layer may have a width equal to the width of the bottom surface 111a. Alternatively, the adhesive layer may have a width that is less than the width of the bottom surface 111a. The adhesive layer may be any appropriate adhesive, such as a polyamide adhesive, a polyurethane adhesive, a polyolefin adhesive, or an ultraviolet [UV]-active adhesive (e.g., an epoxy; an acrylate such as a cyanoacrylate, acrylic acid, methacrylic acid, esters or amides of such acids, substituted variants of such [meth]acrylic acids, esters, or amides; a parylene; a silicone precursor; or other UV-active adhesive known in the art).

Additionally, the width of U-shaped slot 111 corresponds to that of optical subassembly 120 (e.g., is equal to or slightly larger than the width of optical subassembly 120) so that there is substantially no gap between optical subassembly 120 and U-shaped slot 111 when the optical subassembly 120 is mounted in the U-shaped slot 111. Therefore, the tight fit of the optical subassembly 120 in the U-shaped slot 111 can prevent the laser beam from being emitted between the optical subassembly 120 and U-shaped slot 111 because there is no gap between them. That is to say, the entire laser beam is emitted through optical subassembly 120, resulting in low insertion loss.

In one embodiment of the present invention, the length of the U-shaped slot 111 is greater than the length of optical subassembly 120 so that the U-shaped slot 111 can completely accommodate optical subassembly 120. As a result, optical subassembly 120 can be completely encompassed in the magnetic field created by the magnetic support, and thus the magnetic effects of the magnetic field can be applied to the entire length of the optical subassembly 120. Additionally, in the described arrangement the magnetic support 110 protects the optical subassembly 120 from other devices.

The description of an optical fiber free space isolator provided above is meant to illustrate the present invention, but does not limit the invention. Other variants and modifications are encompassed by the present invention without departing from the spirit or scope of the invention.

FIG. 4 is a diagram showing a process flow of an exemplary method of assembling an optical fiber free space isolator in accordance with the present invention. As shown in the figure, the method of assembling the optical fiber free space isolator includes several steps, which are discussed below.

S101: Form a U-shaped slot in a magnetic support. The slot can be formed by milling a U-shaped slot 111 into a cylindrical magnet structure using techniques known in the art to form the magnetic support 110. The U-shaped slot may have a width dimension equal to or just slightly larger than a width of the optical subassembly 120 to be housed therein. Such an arrangement allows the optical subassembly to fit snugly inside the U-shaped slot 111, and thereby prevent the any portion of an emitted laser beam from being lost to gaps between the optical subassembly 120 and the U-shaped slot 111.

The U-shaped slot 111 may have a length greater than that of the optical subassembly 120 to be housed therein, thereby allowing the optical subassembly to be completely encompassed by the magnetic field created by the magnetic support 110.

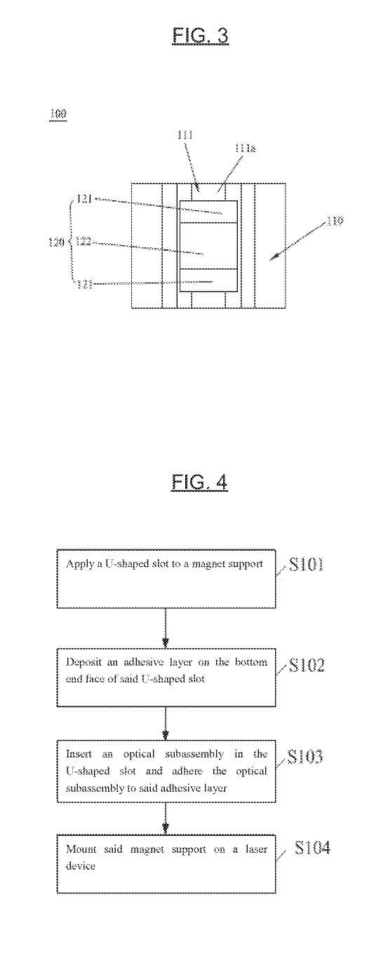

S102: Apply a layer of adhesive to the bottom surface 111a (see FIGS. 1 and 3) of the U-shaped slot 111. In this step, a layer of adhesive is deposited on the bottom surface 111a of U-shaped slot 111 with a mechanical dispenser capable of precise control of the position and volume of the adhesive deposited to form the adhesive layer. For example, the adhesive may be applied using a nozzle, a pump, a syringe, a needle, or a sprayer that is controlled by a mechanical apparatus, as is known in the art. Alternatively, the adhesive may be dispensed by a hand-held device. For instance, the adhesive can be dispensed by a syringe controlled mechanically or by hand. The deposition of the adhesive layer on the bottom surface 111a of the U-shaped slot 111 may be sufficiently accurate prevent the application of adhesive to other surfaces (e.g., side wall surfaces) of the U-shaped slot 111 or any other portion of the magnetic support 110. This results in an improved quality of the assembled optical fiber free space isolator. Additionally, the adhesive layer may be applied only to the bottom surface 111a of the U-shaped slot 111, which may prevent the adhesive layer from interfering (e.g., blocking, diffracting, etc.) with any portion of an emitted laser beam, and thus further ensure that a laser device on which the optical fiber free space isolator is mounted will work properly.

S103: Insert the optical subassembly 120 in the U-shaped slot 111, and adhere the optical subassembly to the adhesive layer to secure the optical subassembly in the U-shaped slot 111. In this step, the optical assembly 120 is placed in the U-shaped slot 111 using a mechanical apparatus capable of precisely placing the optical subassembly 120 into the U-shaped slot 111 (which may be a tight fit), such as a mechanical arm. The optical assembly may be pressed into the U-shaped slot 111 until the optical subassembly 120 reaches the adhesive layer on the bottom surface 111a of the U-shaped slot 111.

Once the optical subassembly is in contact with the adhesive layer, continuous pressure may be applied to the optical subassembly 120 during a process of bonding it to the adhesive layer. The bonding process may include the application of pressure, heat, and/or radiation to the adhesive layer to bond the optical subassembly 120 to the adhesive layer.

The adhesive may be any appropriate adhesive, such as a polyamide adhesive, a polyurethane adhesive, a polyolefin adhesive, or an ultraviolet [UV]-active adhesive (e.g., an epoxy; an acrylate such as a cyanoacrylate, acrylic acid, methacrylic acid, esters or amides of such acids, substituted variants of such [meth]acrylic acids, esters, or amides; a parylene; a silicone precursor; or other UV-active adhesive known in the art). In some cases, the adhesive may comprise a linkable adhesive (e.g., an epoxy compound, an acrylate, a urethane, etc.) and an UV-activator (e.g., a benzophenone activator in the case of an acrylate, a diamine and/or polyamine in the case of an epoxy, etc.). Adhering the optical subassembly 120 to the adhesive layer may include a curing step. If a UV-active glue is used, the glue must be cured by applying UV radiation to the adhesive, otherwise heat may be used to bond the adhesive layer to the optical subassembly 120 (e.g., in the case of a polyamide adhesive, a polyurethane adhesive, a polyolefin adhesive, etc.). The curing step (e.g., the application of UV irradiation and/or heat) must be conducted for a period sufficient to solidify the adhesive and bind the optical subassembly to the U-shaped slot 111.

In the case that a UV-active adhesive is used, a two-step bonding process may be used to bond the optical subassembly 120 to the adhesive layer. For instance, a first low dose of UV radiation (e.g., one or more wavelengths in the range of 100 to 400 nm) may be applied to the adhesive layer for 1 to 15 seconds (e.g., 3 to 10 seconds, or any other value or range of values therein) before the optical subassembly 120 is placed in the U-shaped slot 111 in order to activate the adhesive so that it adheres to the optical subassembly when it is placed in the U-shaped slot 111.

The first irradiation may then be followed by a second UV irradiation, in which a relatively high dose of UV radiation is applied to the adhesive. The second dose of UV radiation is applied for a length of time that is sufficient to solidify the adhesive and form a strong bond between the optical subassembly 120 and the adhesive layer (e.g., 30 seconds to 10 mins., 1 to 5 mins., 2 to 3 mins., etc.), thereby securing the optical subassembly in the U-shaped slot 111 of the magnetic support 110. Alternatively, the bonding process may include a single, high dose of UV radiation applied to the adhesive layer after the optical subassembly 120 is in contact with the adhesive layer.

To improve the efficiency and convenience of the present method, the U-shaped slot 111 may be the same width as or slightly wider than the optical subassembly 120, so that the optical subassembly can be fixed snuggly in the U-shaped slot 111, and the laser emitted from a laser device 200 may be prevented from being emitted into a gap between the optical subassembly 120 and the U-shaped slot 111. A tight fit between the optical subassembly 120 and the U-shaped slot 111 will reduce insertion loss of the laser, and improve the performance of the laser device 200.

S104: Mount the magnetic support 110 on a laser device 200. In this step, the magnetic support 110 is mounted on the laser device 200 with the optical subassembly 120 inserted in the U-shaped slot 111 and bonded to the adhesive layer. That is to say, the whole optical fiber free space isolator may be mounted on the laser device 200, enabling the laser device 200 to operate properly with optical fiber free space isolator connected thereto.

The optical fiber free space isolator 100 may be mounted on the laser device 200 by either mechanical means or by adhesion. For instance, the optical fiber free space isolator may be attached to the laser device with screws, bolts, clamps, or other mechanical means. Alternatively, optical fiber free space isolator 100 may be bonded to the laser device 200 using solder or adhesives and bonding methods similar to those described above.

In all cases, the optical fiber free space isolator 100 may be aligned with the laser source of laser device 200, such that an emitted laser beam is concentric with the optical subassembly 120 of the optical fiber free space isolator 100.

In addition, the length of the U-shaped slot 111 may be configured to be greater than the length of the optical subassembly. In this arrangement, the optical subassembly 120 can be completely encompassed within the U-shaped slot 111, which results in the application of a magnetic field generated by the magnetic support 110 to the entire length of the optical fiber free space isolator 100, and the protection of the optical fiber free space isolator 100 by the magnetic support 110 from other devices.

Moreover, the presently disclosed method allows automation of the manufacture of optical fiber free space isolators. Any appropriate external automated manufacturing equipment (e.g., a computer-controlled mechanical arm) may perform part or all of the above-mentioned steps S102 and S103 of the assembly method. In some embodiments, the entire assembly method may be conducted by automated mechanical means, such as a computer controlled assembly line. The presently disclosed method results in reliable assembly yield, facilitating improved automated mass production and manufacturing efficiency.

It will be apparent to those skilled in the art that modifications and variations can be made in the present invention without departing from the spirit or scope of the inventions. The present invention is not limited to embodiments described above. It will be understood that the descriptions herein are not intended to limit the invention, and the invention is intended to cover modifications and variations that may be included within the spirit and scope of the appended claims.

What is claimed is:

1. An optical isolator, comprising:
a) a magnetic support fixed to the output port of a laser, the magnetic support having a U-shaped slot; and
b) an optical subassembly fixed to the magnetic support, wherein said optical subassembly is inside said U-shaped slot.

2. The optical isolator of claim 1, wherein a width of said U-shaped slot corresponds to a width of said optical subassembly.

3. The optical isolator of claim 1, wherein a length of said U-shaped slot is greater than a length of said optical subassembly.

4. The optical isolator of claim 1, wherein a center line of said magnetic support aligns with a center line of the laser.

5. The optical isolator of claim 4, wherein a center line of said optical subassembly aligns with the center line of the magnetic support.

6. The optical isolator of claim 1, further comprising an adhesive layer over a bottom surface of said U-shaped slot that bonds the optical subassembly to said U-shaped slot.

7. The optical isolator of claim 1, wherein said optical subassembly includes one or more polarizers and an optical rotator.

8. The optical isolator of claim 1, wherein a width of the U-shaped slot is equal to or slightly larger than to a width of the optical subassembly.

9. A method of assembling an optical isolator, comprising:
a) applying an adhesive layer to a bottom surface of a U-shaped slot in a magnetic support;
b) inserting an optical subassembly into the U-shaped slot and bonding the optical subassembly to the adhesive layer; and
c) mounting the magnetic support on a laser device.

10. The method of claim 9, further comprising forming the U-shaped slot in the magnetic support prior to applying the adhesive layer.

11. The method of claim 9, wherein a width of the U-shaped slot corresponds to a width of the optical subassembly.

12. The method of claim 9, wherein a length of the U-shaped slot is greater than a length of the optical subassembly.

13. The method of claim 9, wherein inserting the optical subassembly into the U-shaped slot and bonding the optical subassembly to the adhesive layer are automated processes.

14. The method of claim 9, wherein inserting the optical subassembly into the U-shaped slot is performed by a mechanical arm.

15. The method of claim 9, wherein a center line of the magnetic support aligns with a center line of the laser device.

16. The method of claim 9, wherein a center line of the optical subassembly aligns with the center line of the magnetic support.

17. The method of claim 9, wherein the optical subassembly is concentrically aligned with the laser device.

18. The method of claim 9, wherein bonding the optical subassembly to the adhesive layer comprises curing the adhesive layer.

19. The method of claim 9, wherein the method of assembling an optical isolator is an automated process.
